(19) United States
(12) Patent Application Publication
(10) Pub. No.: US 2026/0175717 A1
(43) Pub. Date: Jun. 25, 2026

(54) Multifunctional Mechanically Reconfigurable Charging Ports for Electric Vehicles and Operating Thereof

(71) Applicant: Harbinger Motors Inc., Garden Grove, CA (US)

(72) Inventor: Phillip John Weicker, Hermosa Beach, CA (US)

(21) Appl. No.: 19/428,577

(22) Filed: Dec. 22, 2025

Related U.S. Application Data
(60) Provisional application No. 63/737,362, filed on Dec. 20, 2024.

(51) Int. Cl. B60L 53/16

(52) U.S. Cl. CPC B60L 53/16

(57) ABSTRACT

Described herein are mechanically reconfigurable charging ports for electric vehicles and methods of operating electric vehicles comprising such ports. A charging port comprises external contacts, internal contacts, and a mechanical switch comprising a movable interconnecting unit and an actuator configured to change the position of the movable interconnecting unit relative to the external contacts and the internal contacts based on one of the operating modes of the charging port. Specifically, the movable interconnecting unit comprises a support and interconnectors attached to and supported by the interconnector support. Depending on the operating mode/position of the movable interconnecting unit, the interconnectors are for connections between different subsets of the external contacts and internal contacts. For example, the mechanically reconfigurable charging ports may support a combined DC-changing and export-power mode, an AC charging-only mode, a DC charging-only mode, and an export power-only mode.

### CROSS-REFERENCE TO RELATED APPLICATIONS

This application claims the benefit under 35 U.S.C. § 119 (e) of U.S. Provisional Patent Application 63/737,362, filed on 2024 Dec. 20, which is incorporated herein by reference in its entirety for all purposes.

### BACKGROUND

Electric vehicles (e.g., battery electric vehicles, plug-in hybrid electric vehicles) utilize battery packs for storing electrical energy. These battery packs require periodic recharging and, in some examples, may be used for powering external devices (e.g., in a vehicle-to-grid (V2G), vehicle-to-home (V2H), vehicle-to-load (V2L), vehicle-to-vehicle (V2V), and vehicle-to-building (V2B), which may be collectively referred to as a vehicle-to-everything (V2X) approach. Specifically, vehicle recharging may involve connecting to various power sources, which may provide alternating current (AC) power or direct current (DC) power. The power sources may take various forms and may be collectively referred to as electric vehicle supply equipment (EVSE). The charging process may involve: (1) establishing a physical connection with the vehicle, (2) performing a logical handshake to exchange necessary information (e.g., battery capacity and energy levels), and (3) closing vehicle contactors to enable energy transfer from the EVSE to the vehicle's battery system. However, due to the EVSE diversity (e.g., AC vs. DC) and expansion of V2X applications, vehicle charging ports for establishing connections with EVSE and V2X devices become progressively more complicated, requiring additional contacts. For example, the North American Charging System (NACS) uses a set of shared AC and DC pins that rely on contractors to switch/reconfigure.

What is needed are multifunctional mechanically reconfigurable charging ports that allow the reconfiguration of the same set of contacts for different charging applications.

### SUMMARY

Described herein are mechanically reconfigurable charging ports for electric vehicles and methods of operating electric vehicles comprising such ports. A charging port comprises external contacts, internal contacts, and a mechanical switch comprising a movable interconnecting unit and an actuator configured to change the position of the movable interconnecting unit relative to the external contacts and the internal contacts based on one of the operating modes of the charging port. Specifically, the movable interconnecting unit comprises a support and interconnectors attached to and supported by the interconnector support. Depending on the operating mode/position of the movable interconnecting unit, the interconnectors are for connections between different subsets of the external contacts and internal contacts. For example, the mechanically reconfigurable charging ports may support a combined DC-changing and export-power mode, an AC charging-only mode, a DC charging-only mode, and an export-power-only mode.
Clause 1. A multifunctional mechanically reconfigurable charging port for an electric vehicle comprising an onboard charger, a battery, and a system controller, the multifunctional mechanically reconfigurable charging port comprising: external contacts for forming electrical connections to external components, wherein the external contacts comprise at least a first charge contact and a second charge contact; internal contacts comprising a first DC contact, a second DC contact, a first AC contact, and a second AC contact, wherein: the first AC contact and the second AC contact are configured to form electrical connections to the onboard charger of the electric vehicle, and the first DC contact and the second DC contact are configured to form electrical connections to the battery of the electric vehicle; and a mechanical switch comprising a movable interconnecting unit and an actuator mechanically coupled to the movable interconnecting unit and configured to change position of the movable interconnecting unit relative to the external contacts and the internal contacts based on one of operating modes of the multifunctional mechanically reconfigurable charging port received from the system controller, wherein: the movable interconnecting unit comprises a support and interconnectors attached to and supported by the support, the interconnectors comprise at least a first interconnector and a second interconnector, the first interconnector is configured to form an electrical connection between the first charge contact and one of the first DC contact and the first AC contact based on the position of the movable interconnecting unit relative to the external contacts and the internal contacts, and the second interconnector is configured to form an electrical connection between the second charge contact and one of the second DC contact and the second AC contact based on the position of the movable interconnecting unit relative to the external contacts and the internal contacts.
Clause 2. The multifunctional mechanically reconfigurable charging port of clause 1, wherein: the external contacts further comprise a first power export contact and a second power export contact, the first interconnector is configured to form an electrical connection between the first power export contact and the first AC contact based on the position of the movable interconnecting unit relative to the external contacts and the internal contacts, and the second interconnector is configured to form an electrical connection between the second power export contact and the second AC contact based on the position of the movable interconnecting unit relative to the external contacts and the internal contacts.
Clause 3. The multifunctional mechanically reconfigurable charging port of clause 2, wherein: the interconnectors further comprise a third interconnector and a fourth interconnector, the third interconnector is configured to form an electrical connection between the first power export contact and the first AC contact when the first interconnector forms the electrical connection between the first charge contact and the first DC contact, and the fourth interconnector is configured to form an electrical connection between the second power export contact and the second AC contact when the second interconnector forms the electrical connection between the second charge contact and the second DC contact.
Clause 4. The multifunctional mechanically reconfigurable charging port of clause 3, wherein: the operating modes comprise a combined DC-changing and export-power mode, and when the position of the movable interconnecting unit relative to the external contacts and the internal contacts is according to the combined DC-changing and export-power mode: (a) the first interconnector forms the electrical connection between the first charge contact and the first DC contact, (b) the second interconnector forms the electrical connection between the second charge contact and the second DC contact, (c) the third interconnector forms the electrical connection between the first power export contact and the first AC contact, and (d) the fourth interconnector forms the electrical connection between the second power export contact and the second AC contact.
Clause 5. The multifunctional mechanically reconfigurable charging port of clause 3, wherein: the operating modes comprise an AC charging-only mode, and when the position of the movable interconnecting unit relative to the external contacts and the internal contacts is according to the AC charging-only mode: (a) the first interconnector forms the electrical connection between the first charge contact and the first AC contact, (b) the second interconnector forms the electrical connection between the second charge contact and the second AC contact, and (c) each of the third interconnector and the fourth interconnector is disconnected from any of the internal contacts.
Clause 6. The multifunctional mechanically reconfigurable charging port of clause 3, wherein: the operating modes comprise an export power-only mode, and when the position of the movable interconnecting unit relative to the external contacts and the internal contacts is according to the export power-only mode: (a) the first interconnector forms the electrical connection between the first power export contact and the first AC contact, (b) the second interconnector forms the electrical connection between the second power export contact and the second AC contact, and (c) each of the third interconnector and the fourth interconnector is disconnected from any of the internal contacts.
Clause 7. The multifunctional mechanically reconfigurable charging port of clause 3, wherein: the operating modes comprise a DC charging-only mode, and when the position of the movable interconnecting unit relative to the external contacts and the internal contacts is according to the DC charging-only mode: (a) the third interconnector forms the electrical connection between the first charge contact and the first DC contact, (b) the fourth interconnector forms the electrical connection between the second charge contact and the second DC contact, and (c) each of the first interconnector and the second interconnector is disconnected from any of the internal contacts.
Clause 8. The multifunctional mechanically reconfigurable charging port of clause 1, further comprising the system controller comprising a memory with the operating modes stored in the memory, wherein the system controller is configured to receive input from one or more systems of the electric vehicle for selecting one of the operating modes.
Clause 9. The multifunctional mechanically reconfigurable charging port of clause 8, wherein the system controller is configured to coordinate the operation of the actuator with the onboard charger.
Clause 10. The multifunctional mechanically reconfigurable charging port of clause 8, wherein the system controller is configured to inhibit movement of the actuator while electrical power is being transferred through the external contacts.
Clause 11. The multifunctional mechanically reconfigurable charging port of clause 8, wherein the system controller is configured to verify the position of the movable interconnecting unit prior to enabling power transfer.
Clause 12. The multifunctional mechanically reconfigurable charging port of clause 8, wherein the input received from one or more systems of the electric vehicle is selected from the group consisting of (a) a voltage readings on the first charge contact and the second charge contact, (b) battery management system input, and (c) and a sensor input from one or more sensors of the multifunctional mechanically reconfigurable charging port.
Clause 13. The multifunctional mechanically reconfigurable charging port of clause 12, wherein the system controller is configured to determine whether an external power source is an AC power source or a DC power source based on the voltage readings on the first charge contact and the second charge contact.
Clause 14. The multifunctional mechanically reconfigurable charging port of clause 12, wherein the one or more sensors comprise at least one sensor selected from the group consisting of: a position sensor configured to detect a position of the movable interconnecting unit, a current sensor configured to detect current flowing through one or more of the external contacts or the internal contacts, a temperature sensor configured to detect temperature of one or more of the external contacts, the internal contacts, the interconnectors, or the actuator, and a proximity sensor configured to detect engagement of an external connector with the external contacts.
Clause 15. The multifunctional mechanically reconfigurable charging port of clause 8, wherein the system controller is configured to select the one of the operating modes based on at least one factor selected from the group consisting of an available power type, an available power level, a state of charge of the battery, a grid demand condition, a user authorization input, and a requested direction of power flow.
Clause 16. The multifunctional mechanically reconfigurable charging port of clause 1, wherein the support is formed from an electrically insulating material configured to maintain electrical isolation between the interconnectors.
Clause 17. The multifunctional mechanically reconfigurable charging port of clause 1, wherein the support has a cylindrical shape enabling rotational movement of the movable interconnecting unit.
Clause 18. The multifunctional mechanically reconfigurable charging port of clause 1, wherein the actuator is a rotary actuator.
Clause 19. The multifunctional mechanically reconfigurable charging port of clause 1, wherein the operating modes are mutually exclusive.
Clause 20. The multifunctional mechanically reconfigurable charging port of clause 1, further comprising a mechanical locking feature configured to maintain the movable interconnecting unit in a selected one of the operating modes.
Clause 21. An electric vehicle comprising: a multifunctional mechanically reconfigurable charging port comprising external contacts, internal contacts, and a mechanical switch, wherein the mechanical switch comprises a movable interconnecting unit and an actuator mechanically coupled to the movable interconnecting unit; an onboard charger; a battery connected to the onboard charger; and a system controller configured to select one of operating modes of the multifunctional mechanically reconfigurable charging port and instruct the actuator to change position of the movable interconnecting unit relative to the external contacts and the internal contacts based on the one of the operating modes selected by the system controller. The external contacts are configured to form electrical connections to external components and comprise at least a first charge contact and a second charge contact, the internal contacts comprise a first DC contact, a second DC contact, a first AC contact, and a second AC contact, the first AC contact and the second AC contact are connected to the onboard charger, the first DC contact and the second DC contact are connected to the battery of the electric vehicle.
Clause 22. The electric vehicle of clause 21, wherein the actuator is a rotary actuator configured to rotate the movable interconnecting unit between discrete positions corresponding to predefined operating modes.
Clause 23. The electric vehicle of clause 21, wherein: the movable interconnecting unit comprises a support and interconnectors attached to and supported by the support, the interconnectors comprise at least a first interconnector and a second interconnector, the first interconnector is configured to form an electrical connection between the first charge contact and one of the first DC contact and the first AC contact based on the position of the movable interconnecting unit relative to the external contacts and the internal contacts, and the second interconnector is configured to form an electrical connection between the second charge contact and one of the second DC contact and the second AC contact based on the position of the movable interconnecting unit relative to the external contacts and the internal contacts.
Clause 24. The electric vehicle of clause 23, wherein the support is formed from an electrically insulating material configured to maintain electrical isolation between the interconnectors.
Clause 25. The electric vehicle of clause 23, wherein the interconnectors are electrically isolated from one another by the support.
Clause 26. The electric vehicle of clause 23, wherein the external contacts further comprise a first power export contact and a second power export contact.
Clause 27. The electric vehicle of clause 26, wherein the first interconnector is configured to form an electrical connection between the first power export contact and the first AC contact based on the position of the movable interconnecting unit.
Clause 28. The electric vehicle of clause 26, wherein the second interconnector is configured to form an electrical connection between the second power export contact and the second AC contact based on the position of the movable interconnecting unit.
Clause 29. The electric vehicle of clause 21, wherein the operating modes comprise an AC charging-only mode, a DC charging-only mode, an export-power-only mode, and a combined DC charging and export-power mode.
Clause 30. The electric vehicle of clause 29, wherein the operating modes are mutually exclusive.
Clause 31. The electric vehicle of clause 21, wherein the system controller is configured to receive input from one or more systems of the electric vehicle for selecting the operating mode.
Clause 32. The electric vehicle of clause 31, wherein the input is selected from the group consisting of: (a) voltage readings on the first charge contact and the second charge contact, (b) battery management system input, and (c) sensor input from one or more sensors of the multifunctional mechanically reconfigurable charging port.
Clause 33. The electric vehicle of clause 32, wherein the one or more sensors comprise at least one sensor selected from the group consisting of: a position sensor configured to detect position of the movable interconnecting unit, a current sensor configured to detect current flowing through one or more of the external contacts or the internal contacts, a temperature sensor configured to detect temperature of one or more of the external contacts, the internal contacts, or the actuator, and a proximity sensor configured to detect engagement of an external connector with the external contacts.
Clause 34. The electric vehicle of clause 21, wherein the system controller is configured to select the operating mode based on at least one factor selected from the group consisting of an available power type, an available power level, a state of charge of the battery, a grid demand condition, a user authorization input, and a requested direction of power flow.
Clause 35. The electric vehicle of clause 21, wherein the system controller is configured to verify a position of the movable interconnecting unit before enabling power transfer.
Clause 36. The electric vehicle of clause 21, wherein the system controller is configured to inhibit movement of the actuator while electrical power is being transferred through the charging port.
Clause 37. The electric vehicle of clause 21, wherein the system controller is configured to receive an operating mode selection input from one or more of (1) an external device communicatively coupled to the system controller and (2) an external system controller associated with external charging equipment.
Clause 38. The electric vehicle of clause 37, wherein the external system controller is associated with a power grid, a microgrid, or a vehicle-to-grid system.
Clause 39. The electric vehicle of clause 21, wherein the electric vehicle is a commercial vehicle selected from the group consisting of a step van, a box truck, a utility vehicle, a service vehicle, an emergency vehicle, a shuttle bus, a passenger van, a recreational vehicle, a tow truck, a dump truck, and a refrigerated truck.
Clause 40. The electric vehicle of clause 21, wherein the multifunctional mechanically reconfigurable charging port is configured to enable cross-charging between the electric vehicle and one or more additional electric vehicles located at a common site.
Clause 41. A method of operating an electric vehicle comprising a multifunctional mechanically reconfigurable charging port, an onboard charger, a battery, and a system controller, the method comprising: receiving, at the system controller, one or more inputs; selecting, by the system controller, one of operating modes for the multifunctional mechanically reconfigurable charging port, wherein: the multifunctional mechanically reconfigurable charging port comprises external contacts, internal contacts, and a mechanical switch comprising a movable interconnecting unit and an actuator, the external contacts comprise at least a first charge contact and a second charge contact, the internal contacts comprise a first DC contact, a second DC contact, a first AC contact, and a second AC contact, the actuator is mechanically coupled to the movable interconnecting unit, and the movable interconnecting unit comprises a support and interconnectors attached to and supported by the support and comprising at least a first interconnector and a second interconnector; and changing, using the actuator, position of the movable interconnecting unit relative to the external contacts and the internal contacts based on the one of the operating modes of the multifunctional mechanically reconfigurable charging port selected by the system controller.
Clause 42. The method of clause 41, wherein the one or more inputs are selected from the group consisting of: (a) voltage readings on the first charge contact and the second charge contact, (b) battery management system input, and (c) sensor input from one or more sensors of the multifunctional, mechanically reconfigurable charging port.
Clause 43. The method of clause 42, wherein the one or more sensors comprise at least one sensor selected from the group consisting of: a position sensor configured to detect a position of the movable interconnecting unit, a current sensor configured to detect current flowing through one or more of the external contacts or the internal contacts, a temperature sensor configured to detect temperature of one or more of the external contacts, the internal contacts, the interconnectors, or the actuator, and a proximity sensor configured to detect engagement of an external connector with the external contacts.
Clause 44. The method of clause 41, wherein receiving the one or more inputs comprises receiving an operating mode selection input from one or more of (1) an external device communicatively coupled to the system controller and (2) an external system controller associated with external charging equipment.
Clause 45. The method of clause 44, wherein the external system controller is associated with a power grid, a microgrid, or a vehicle-to-grid system.
Clause 46. The method of clause 44, wherein the external device comprises a user computing device configured to provide user authorization or a requested operating mode.
Clause 47. The method of clause 41, wherein selecting the one of the operating modes comprises selecting from an AC charging-only mode, a DC charging-only mode, an export-power-only mode, and a combined DC charging and export-power mode.
Clause 48. The method of clause 41, wherein the operating modes are mutually exclusive.
Clause 49. The method of clause 41, wherein selecting the one of the operating modes is based on at least one factor selected from the group consisting of an available power type, an available power level, a state of charge of the battery, a grid demand condition, a user authorization input, and a requested direction of power flow.
Clause 50. The method of clause 41, wherein selecting the one of the operating modes comprises determining whether an external power source is an AC power source or a DC power source based on voltage readings on the first charge contact and the second charge contact.
Clause 51. The method of clause 47, wherein selecting the AC charging-only mode comprises determining that an AC power source is connected and that power export is not requested.
Clause 52. The method of clause 47, wherein selecting the DC charging-only mode comprises determining that DC charging power is available and that direct charging of the battery is permitted.
Clause 53. The method of clause 47, wherein selecting the export-power-only mode comprises determining that a request for power export is received and that sufficient energy is available in the battery.
Clause 54. The method of clause 47, wherein selecting the combined DC charging and export-power mode comprises determining that DC charging power is available and that a simultaneous request for power export is present.
Clause 55. The method of clause 41, further comprising verifying the position of the movable interconnecting unit before enabling power transfer.
Clause 56. The method of clause 41, further comprising inhibiting the movement of the actuator while electrical power is being transferred through the external contacts.
Clause 57. The method of clause 41, wherein changing the position of the movable interconnecting unit comprises rotating the movable interconnecting unit using a rotary actuator.
Clause 58. The method of clause 41, further comprising operating the electric vehicle in accordance with the selected operating mode by charging the battery or exporting power through the charging port.
Clause 59. The method of clause 41, further comprising exporting power from the battery to an external load through the multifunctional mechanically reconfigurable charging port.
Clause 60. The method of clause 41, further comprising coordinating operation of the charging port with one or more additional electric vehicles located at a common site.

These and other embodiments are described further below with reference to the figures.

### BRIEF DESCRIPTION OF THE DRAWINGS

FIGS. 1A-1C are schematic block diagrams of different types of charging ports used on electric vehicles, in accordance with some examples.

FIG. 1D is a schematic side view of an electric vehicle illustrating a multifunctional mechanically reconfigurable charging port interconnected with the battery and the onboard charger, in accordance with some examples.

FIG. 2A is a block diagram of an electric vehicle comprising a multifunctional mechanically reconfigurable charging port, in accordance with some examples.

FIG. 2B illustrates a block diagram of a system controller, in accordance with some examples.

FIG. 3 is a process flowchart corresponding to a method for operating an electric vehicle comprising a multifunctional mechanically reconfigurable charging port, in accordance with some examples.

FIGS. 4A-4D are schematic block diagrams of different operating modes of a multifunctional mechanically reconfigurable charging port, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscuring the described concepts. While some concepts will be described in conjunction with the specific embodiments, it will be understood that these embodiments are not intended to be limiting.

### Introduction

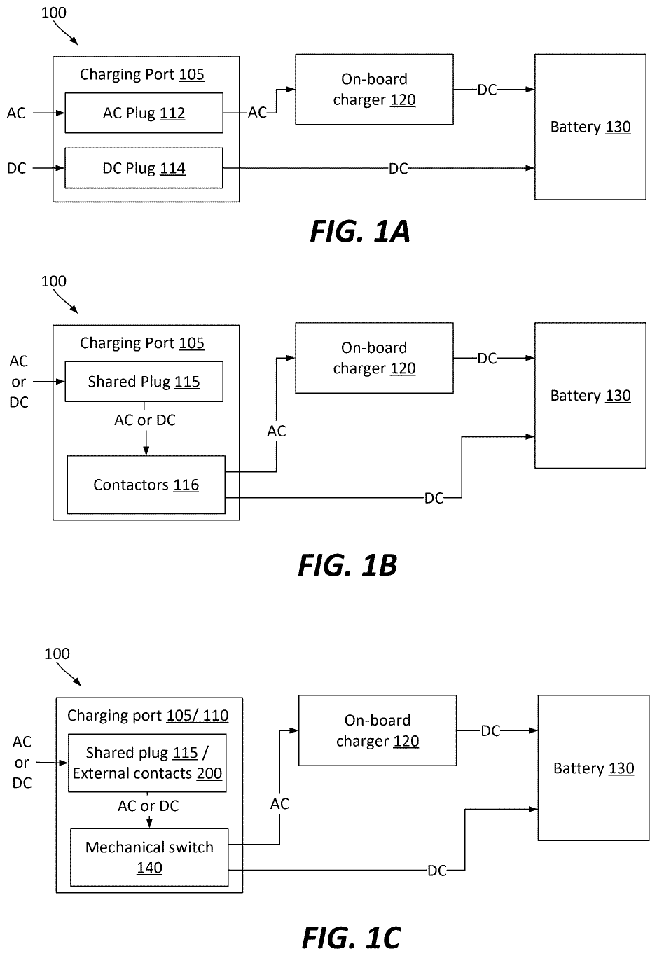

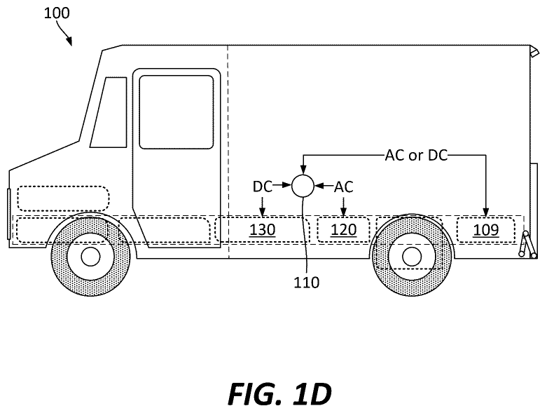

As noted above, the EVSE diversity (e.g., AC vs. DC) and expansion of V2X applications present new requirements for vehicle charging ports, which are addressed with multifunctional mechanically reconfigurable charging ports described herein. For purposes of this disclosure, the term “charging” applies to electrical power supplied to the vehicle battery (from EVSE devices) and also to electrical power supplied by the vehicle battery (for any V2X applications). In other words, the term “charging” applies to any transfer of power through vehicle charging ports. Some examples of such power transfers will now be described with reference to FIGS. 1A-1C.

Specifically, FIG. 1A illustrates an electric vehicle 100 comprising a charging port 105 equipped with both an AC plug 112 and a DC plug 114. These plugs separate from each other, each comprising a set of contacts dedicated to either AC power transmission or DC power transmission. For example, the AC plug 112 may be connected to an onboard charger 120, which converts AC power to DC power for charging a battery 130 and may also be referred to as an inverter. The onboard charger 120 may also be used for converting DC power to AC power, e.g., for the V2X application, which uses both an AC plug 112 or a different plug (e.g., a dedicated plug) not shown in FIG. 1A. The DC plug 114 may be connected to the battery 130 for direct charging of the battery 130 (e.g., in a DC “fast charge” configuration). Bypassing the onboard charger 120 (which is typically rated up to 10-20 kW) allows passing currents exceeding 200 kW and even 300 kW through the DC plug 114. Some examples of AC plugs 112 include, but are not limited to, Type 1 (SAE J1772-a circular connector with 5 pins) and Type 2 (Mennekes-a circular connector with 7 pins). Type 1 is currently used mainly in North America and Japan and supports Level 1 (120V) and Level 2 (240V) charging. Type 2 is currently used in Europe and other regions and supports three-phase charging. Some examples of DC plugs 114 include, but are not limited to, CHAdeMO and CCS (Combined Charging System), supporting charging rates up to 400 KW (depending on the station and vehicle characteristics).

FIG. 1B illustrates another example of an electric vehicle 100 comprising a charging port 105 equipped with a shared plug 115, capable of transmitting both AC and DC power through the same set of contacts (often referred to as pins). One example of a shared plug 115 is a NACS connector, which has a compact oval shape. To direct the power within the electric vehicle 100 to appropriate components, the charging port 105 is also equipped with contactors 116 that direct AC power to the onboard charger 120 and, separately, direct DC power to the battery 130. In other words, when the electric vehicle 100 or, more specifically, the charging port 105 is coupled to an AC power source, the contactors 116 open the circuit to the battery 130 and close the circuit to the onboard charger 120, thereby enabling the AC charging only. On the other hand, when the charging port 105 is coupled to a DC power source, the contactors 116 close the circuit to the battery 130 and open the circuit to the onboard charger 120, thereby enabling the DC charging only.

Unfortunately, contactors 116 experience various issues such as wear and tear from frequent use, overheating during high-current fast charging, and arcing damage when opening or closing under load. Furthermore, contamination from dust or moisture can reduce their conductivity, while faulty control circuits may prevent proper operation. Additionally, the control and circuit complexity of these contactors 116 require expensive materials, thermal management, and software monitoring.

FIG. 1C illustrates yet another example of an electric vehicle 100 comprising a charging port 105, which may be referred to as a multifunctional mechanically reconfigurable charging port 110. Similar to FIG. 1B, the charging port 105 is equipped with a shared plug 115, which may be referred to as external contacts 200 and used for either AC or DC connections. In contrast to the configuration shown in FIG. 1A, which relies on physically separate AC and DC plugs 112, 114, and in contrast to the configuration shown in FIG. 1B, which relies on electrically actuated contactors 116 to route power between the onboard charger 120 and the battery 130, the multifunctional mechanically reconfigurable charging port 110 of FIG. 1C employs a mechanical switch 140 to selectively reconfigure electrical connections within the charging port 110.

In conventional shared-plug architectures such as that illustrated in FIG. 1B, contactors 116 are used to electrically connect the shared plug 115 either to the onboard charger 120 for AC charging or directly to the battery 130 for DC charging. While such contactors 116 reduce the number of external connectors, they introduce significant drawbacks, including electrical arcing during switching, heat generation under high current conditions, increased control complexity, and reduced reliability due to wear, contamination, and repeated actuation.

The multifunctional mechanically reconfigurable charging port 110 addresses these challenges by replacing electrically actuated contactors with the mechanical switch 140, which physically reconfigures the electrical pathways between the external contacts 200 and internal components of the electric vehicle 100. By mechanically changing the position of internal interconnectors relative to the external contacts 200 and internal contacts associated with the onboard charger 120 and the battery 130, the charging port 110 establishes the required electrical connections for AC charging, DC charging, power export, or combined operating modes in a robust and repeatable manner. This mechanical reconfiguration reduces electrical stress during switching events, improves tolerance to high current operation, and simplifies thermal and control requirements.

### Examples of Electric Vehicles

FIG. 1D is a schematic side view of an electric vehicle 100 illustrating a multifunctional mechanically reconfigurable charging port 110, interconnected with the battery 130 and the onboard charger 120. In some examples, the electric vehicle 100 may be equipped with a range extender 109 that is also connected to the multifunctional mechanically reconfigurable charging port 110.

Various types of electric vehicles 100 are within the scope. For example, an electric vehicle 100 may be a step van (also known as a walk-in van), which is a specific type of vehicle that can be defined as a Class 4-6 commercial vehicle (based on the gross vehicle weight rating of about 16,000-26,000 lbs or about 7,000-12,000 kg). A step van features a walk-in cargo area and a driver's cab that is easy to step in and out of and can be used for various delivery and service applications. Other types of vehicles are also within the scope, e.g., box trucks, recreation vehicles (RVs), tow trucks, dump trucks, utility and service trucks, ambulances/emergency vehicles, shuttle buses/passenger vans, refrigerated trucks (reefers), and the like.

As illustrated in FIG. 1D, the multifunctional mechanically reconfigurable charging port 110 provides a centralized electrical interface between external power sources and multiple internal power systems of the electric vehicle 100, including the battery 130, the onboard charger 120, and, in some examples, the range extender 109. This architecture enables flexible support for AC charging, DC charging, power export, and combined operating modes using a shared set of external contacts.

The multifunctional mechanically reconfigurable charging port 110 is particularly advantageous for electric vehicles 100 that are used in commercial, fleet, and specialty applications, where vehicles may encounter diverse charging infrastructure, variable duty cycles, and frequent connection and disconnection events. For example, step vans, box trucks, utility vehicles, and emergency vehicles may require compatibility with both AC and DC charging sources, as well as the ability to export electrical power to external equipment or loads.

In fleet environments where multiple electric vehicles 100 are parked together at a common location, such as depots, service yards, or staging areas, the multifunctional mechanically reconfigurable charging ports 110 enable cross-charging and coordinated power sharing between vehicles. For instance, one or more vehicles having a higher state of charge or access to an external power source may export power to other vehicles through their respective charging ports 110, thereby balancing energy levels across the fleet.

In some examples, multiple electric vehicles 100 parked at the same location may collectively aggregate available electrical power for export to an external system, such as a building, microgrid, or utility power grid. Using the export power and combined operating modes of the multifunctional mechanically reconfigurable charging ports 110, the vehicles may operate as a distributed energy resource, with each vehicle contributing a portion of its available battery capacity or generated power. The system controllers of the respective vehicles may coordinate operation of the charging ports 110 based on external commands, grid demand conditions, or predefined fleet management strategies to support grid balancing, peak shaving, or emergency power supply.

### Examples of Multifunctional Mechanically Reconfigurable Charging Ports

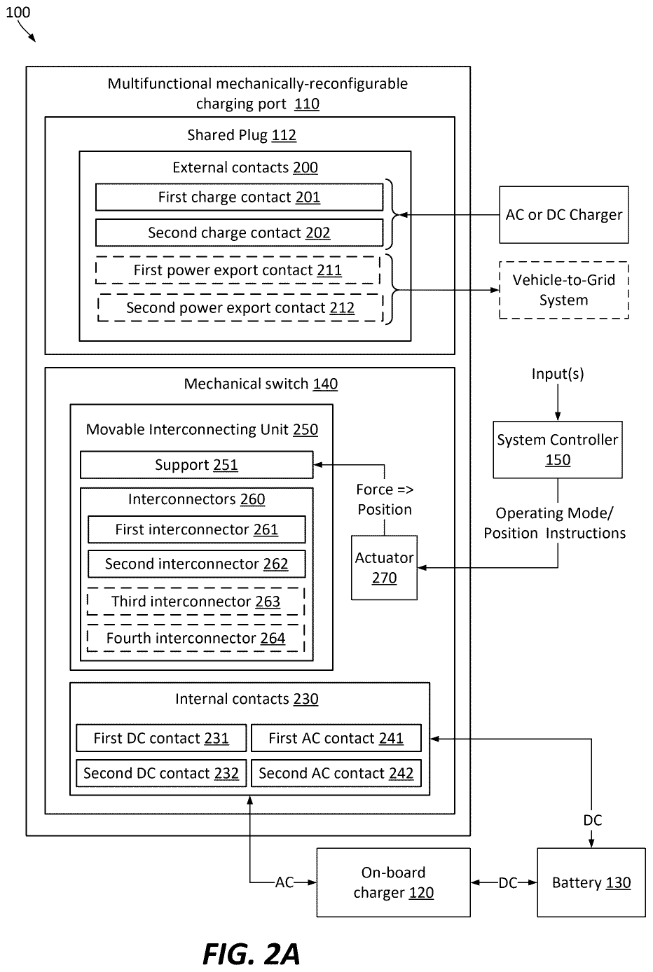

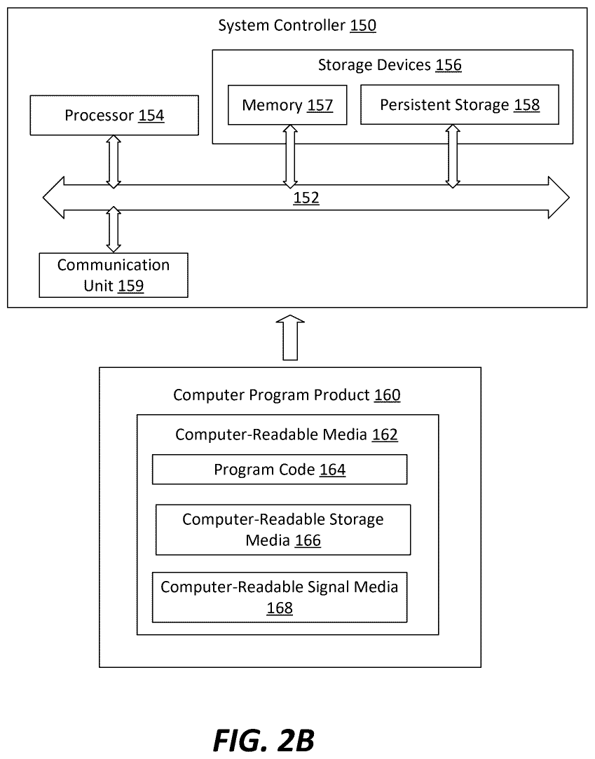

FIG. 2A is a block diagram of an electric vehicle 100 comprising a multifunctional mechanically reconfigurable charging port 110, in accordance with some examples. In addition to the multifunctional mechanically reconfigurable charging port 110, the electric vehicle 100 comprises an onboard charger 120, a battery 130, and a system controller 150. Various examples of electric vehicles 100 are within the scope, as described above.

The onboard charger 120 converts the AC power transmitted through the multifunctional mechanically reconfigurable charging port 110 into the DC power used for charging/discharging the battery 130. The onboard charger 120 also converts DC power from the battery 130 to AC power used by a drive motor, including regulating the frequency and amplitude of the AC power for controlling the motor speed and torque and facilitating the regenerative braking. The battery 130 stores the electric energy for various uses by other systems (e.g., propulsion, heating, lighting).

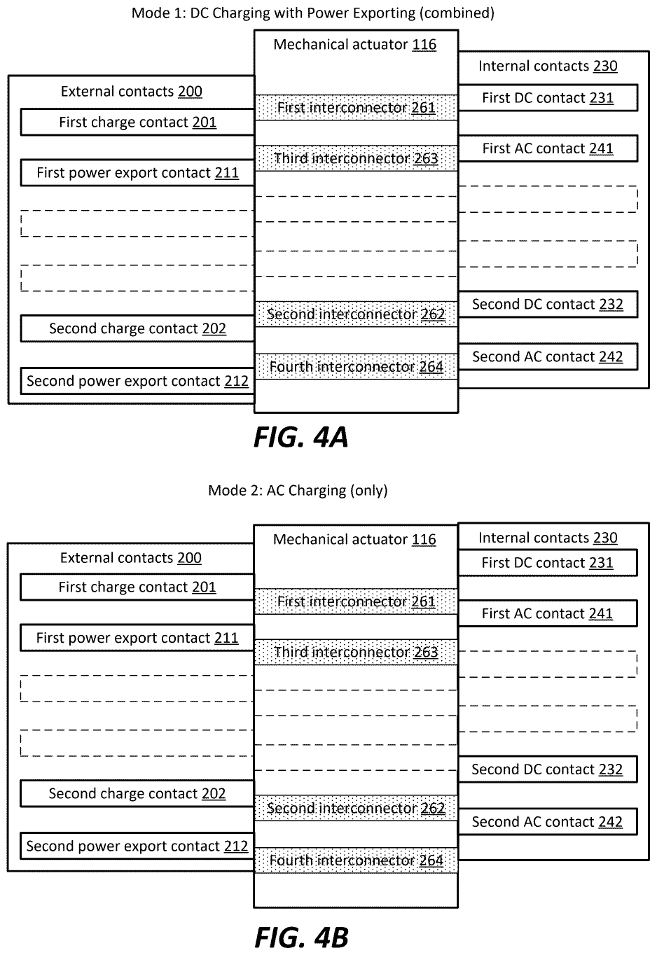

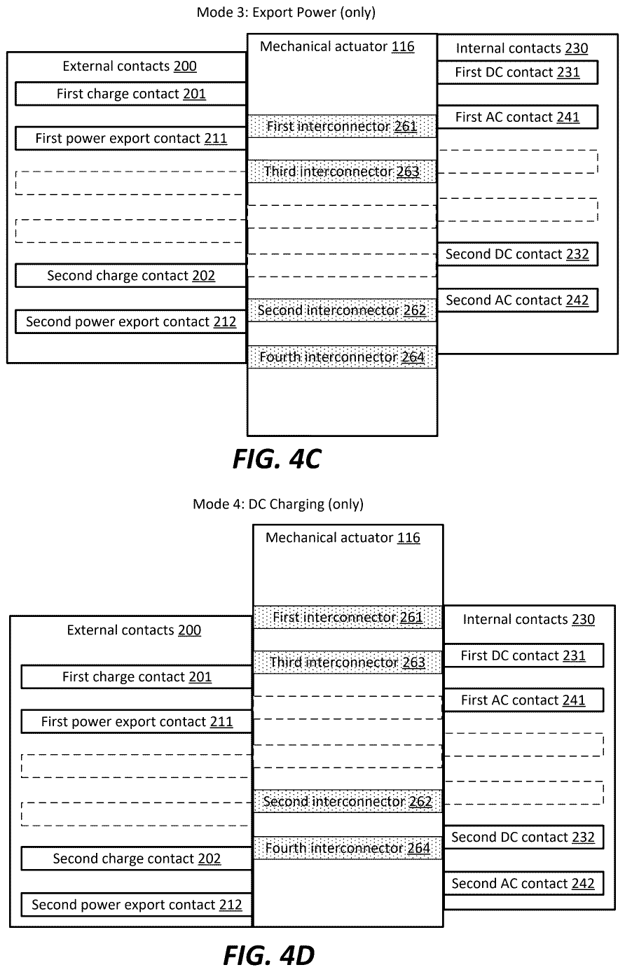

The multifunctional mechanically reconfigurable charging port 110 comprises external contacts 200, internal contacts 230, and a mechanical switch 140. External contacts 200 are used to form electrical connections to external components such as EVSE devices and, in some examples, V2X devices. The external contacts 200 comprise at least a first charge contact 201 and a second charge contact 202, which are used for transmitting either AC power or DC power through the multifunctional mechanically reconfigurable charging port 110, e.g., for charging the battery 130. In some examples, the external contacts 200 further comprise a first power export contact 211 and a second power export contact 212, e.g., for V2X applications. Using both charge contacts and power export contacts enables various operating modes that are further described below with reference to FIGS. 4A-4D.

Internal contacts 230 comprise a first DC contact 231, a second DC contact 232, a first AC contact 241, and a second AC contact 242. The first AC contact 241 and the second AC contact 242 are connected to the onboard charger 120 of the electric vehicle 100, or (prior to the installation of the multifunctional mechanically reconfigurable charging port 110 to the electric vehicle 100) configured to form electrical connections to the onboard charger 120 of the electric vehicle 100. Similarly, the first DC contact 231 and the second DC contact 232 are connected to or configured to form electrical connections to the battery 130 of the electric vehicle 100.

In some examples, the mechanical switch 140 comprises a movable interconnecting unit 250 and an actuator 270 mechanically coupled to the movable interconnecting unit 250. The actuator 270 may be configured to change the position of the movable interconnecting unit 250 relative to the external contacts 200 and the internal contacts 230 based on one of the operating modes of the multifunctional mechanically reconfigurable charging port 110. These operating modes/positions may be received from the system controller 150 as further described below. In some examples, the actuator 270 is a rotary actuator (e.g., a step motor). In other examples, the actuator 270 is a linear actuator. For example, a rotary actuator (and the corresponding configuration of the mechanical switch 140) may potentially rotate “endlessly” in each direction, thereby allowing both clockwise and counterclockwise rotation. This feature enables the mechanical switch 140 to take the shortest path between different modes.

In some examples, the movable interconnecting unit 250 comprises a support 251 and interconnectors 260 attached to and supported by the support 251. The support 251 is formed from an electrically insulating material to maintain the isolation between the interconnectors 260. In some examples, the support 251 may have a round cylindrical shape, e.g., to enable the rotary actuation/positional change.

The interconnectors 260 comprise at least a first interconnector 261 and a second interconnector 262. The first interconnector 261 is configured to form an electrical connection between the first charge contact 201 and one of the first DC contact 231 and the first AC contact 241 based on the position of the movable interconnecting unit 250 relative to the external contacts 200 and the internal contacts 230. Similarly, the second interconnector 262 is configured to form an electrical connection between the second charge contact 202 and one of the second DC contact 232 and the second AC contact 242 based on the position of the movable interconnecting unit 250 relative to the external contacts 200 and the internal contacts 230. Since the first interconnector 261 and the second interconnector 262 are positioned on the same support 251, their relative position remains constant. As such, changing the connection/position of the first interconnector 261 also changes the connection/position of the second interconnector 262.

When the external contacts 200 further comprise a first power export contact 211 and a second power export contact 212, the first interconnector 261 is configured to form an electrical connection between the first power export contact 211 and the first AC contact 241 based on the position of the movable interconnecting unit 250 relative to the external contacts 200 and the internal contacts 230. Furthermore, the second interconnector 262 is configured to form an electrical connection between the second power export contact 212 and the second AC contact 242 based on the position of the movable interconnecting unit 250 relative to the external contacts 200 and the internal contacts 230. As such, the first power export contact 211 and the second power export contact 212 enable the V2X function, which may be performed while the electric vehicle 100 is charged (e.g., using either AC power or DC power) or while the vehicle is not charged.

In some examples, the interconnectors 260 further comprise a third interconnector 263 and a fourth interconnector 264. For example, the third interconnector 263 is configured to form an electrical connection between the first power export contact 211 and the first AC contact 241 when the first interconnector 261 forms the electrical connection between the first charge contact 201 and the first DC contact 231. The fourth interconnector 264 may be configured to form an electrical connection between the second power export contact 212 and the second AC contact 242 when the second interconnector 262 forms the electrical connection between the second charge contact 202 and the second DC contact 232. The addition of the third interconnector 263 and fourth interconnector 264 enables the V2X function while the electric vehicle 100 is charged.

A combination of these interconnectors enables different operating modes of the multifunctional mechanically reconfigurable charging port 110 that are summarized in the table below and presented in FIGS. 4A-4B.

| | Mode/Interconnector Use | | | |
|---|---|---|---|---|
| | Combined DC- | | | |
| | changing and | AC charging - | Export-power | DC charging - |
| | export power | only | only | only |
| | (FIG. 4A) | (FIG. 4B) | (FIG. 4A) | (FIG. 4D) |
| First | First Charge | First Charge | First PE | |
| Interconnector | Contact 201 to | Contact 201 to | Contact 211 to | |
| 261 | First DC | First AC | First AC | |
| | Contact 231 | Contact 241 | Contact 241 | |
| Second | Second Charge | Second Charge | Second PE | |
| Interconnector | Contact 202 to | Contact 202 to | Contact 212 to | |
| 262 | Second DC | Second AC | Second AC | |
| | Contact 232 | Contact 242 | Contact 242 | |
| Third | First PE | | | First Charge |
| Interconnector | Contact 211 to | | | Contact 201 to |
| 263 | First AC | | | First DC |
| | Contact 241 | | | Contact 231 |
| Fourth | Second PE | | | Second Charge |
| Interconnector | Contact 212 to | | | Contact 202 to |
| 264 | Second AC | | | Second DC |
| | Contact 242 | | | Contact 232 |

In some examples, the operating modes comprise a combined DC-changing and export-power mode. Specifically, when the position of the movable interconnecting unit 250 relative to the external contacts 200 and the internal contacts 230 is according to the combined DC-changing and export-power mode (e.g., as shown in FIG. 4A), (a) the first interconnector 261 forms the electrical connection between the first charge contact 201 and the first DC contact 231, (b) the second interconnector 262 forms the electrical connection between the second charge contact 202 and the second DC contact 232, (c) the third interconnector 263 forms the electrical connection between the first power export contact 211 and the first AC contact 241, and (d) the fourth interconnector 264 forms the electrical connection between the second power export contact 212 and the second AC contact 242.

In the same or other examples, the operating modes comprise an AC charging-only mode. Specifically, when the position of the movable interconnecting unit 250 relative to the external contacts 200 and the internal contacts 230 is according to the AC charging only mode (e.g., as shown in FIG. 4B), (a) the first interconnector 261 forms the electrical connection between the first charge contact 201 and the first AC contact 241, (b) the second interconnector 262 forms the electrical connection between the second charge contact 202 and the second AC contact 242, and (c) each of the third interconnector 263 and the fourth interconnector 264 is disconnected from any of the internal contacts 230.

In the same or other examples, the operating modes comprise an export power-only mode. Specifically, when the position of the movable interconnecting unit 250 relative to the external contacts 200 and the internal contacts 230 is according to the export power only mode (e.g., as shown in FIG. 4C), the first interconnector 261 forms the electrical connection between the first power export contact 211 and the first AC contact 241, the second interconnector 262 forms the electrical connection between the second power export contact 212 and the second AC contact 242, and each of the third interconnector 263 and the fourth interconnector 264 is disconnected from any of the internal contacts 230.

In the same or other examples, the operating modes comprise a DC charging-only mode. Specifically, when the position of the movable interconnecting unit 250 relative to the external contacts 200 and the internal contacts 230 is according to the DC charging only mode (e.g., as shown in FIG. 4D), (a) the third interconnector 263 forms the electrical connection between the first charge contact 201 and the first DC contact 231, (b) the fourth interconnector 264 forms the electrical connection between the second charge contact 202 and the second DC contact 232, and (c) each of the first interconnector 261 and the second interconnector 262 is disconnected from any of the internal contacts 230.

Referring to FIGS. 2A and 2B, either the electric vehicle 100 or the multifunctional mechanically reconfigurable charging port 110 may further comprise a system controller 150. The system controller 150 controls the operation of at least the actuator 270 of the mechanical switch 140, thereby enabling different operating modes of the multifunctional mechanically reconfigurable charging port 110. In some examples, the system controller 150 comprises a memory 157 with the operating modes stored in the memory 157, wherein the system controller 150 is configured to receive input from one or more systems of the electric vehicle 100 for selecting one of the operating modes.

FIG. 2B illustrates a block diagram of a system controller 150 configured to operate the multifunctional mechanically reconfigurable charging port 110. The system controller 150 comprises one or more processors 154, storage devices 156, and a communication unit 159, which are communicatively coupled via a communications framework 152 (e.g., a bus). The processor 154 is configured to execute program instructions to control the operation of the mechanical switch 140, including selecting operating modes and instructing the actuator 270 to change the position of the movable interconnecting unit 250.

The storage devices 156 comprise a memory 157 and persistent storage 158. The memory 157 is configured to store program code 164, operating mode information, and temporary data associated with sensor inputs, safety checks, and actuator control. The persistent storage 158 is configured to store program instructions, configuration data, and historical or calibration data used by the system controller 150 during operation of the charging port 110.

The communications framework 152 provides data exchange between the processor 154, the memory 157, the persistent storage 158, and the communication unit 159. The communication unit 159 is configured to communicate with other vehicle systems, external devices, and external system controllers, such as charging equipment or grid controllers, to receive operating mode requests, authorization inputs, power availability information, and other data used by the system controller 150.

In some examples, the program code 164 executed by the processor 154 is provided as part of a computer program product 160. The computer program product 160 comprises computer-readable media 162, which may include computer-readable storage media 166 and computer-readable signal media 168. The computer-readable storage media 166 may be used to store the program code 164 in a non-transitory form, while the computer-readable signal media 168 may be used to transfer the program code 164 to the system controller 150 via one or more communication links.

### Examples of Operating Electric Vehicles with Charging Ports

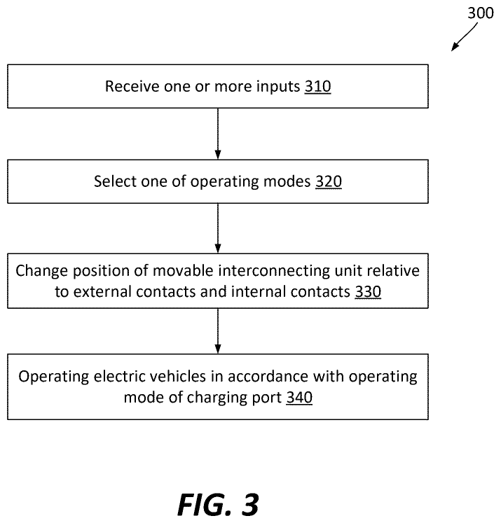

FIG. 3 is a process flowchart corresponding to method 300 for operating an electric vehicle 100 comprising a multifunctional mechanically reconfigurable charging port 110, in accordance with some examples. Additional aspects of the electric vehicle 100 and, more specifically, of the multifunctional mechanically reconfigurable charging port 110 are described above.

Method 300 may comprise (block 310) receiving, at the system controller 150, one or more inputs. Some examples of such inputs include (a) voltage readings on the first charge contact 201 and the second charge contact 202, (b) battery management system (BMS) input, (c) sensor inputs from one or more sensors of the multifunctional mechanically reconfigurable charging port 110, and the like. For example, the sensors may include (1) a position sensor configured to detect a position or orientation of the movable interconnecting unit 250, (2) one or more current sensors configured to detect current flowing through one or more of the external contacts 200 or internal contacts 230, (3) one or more temperature sensors configured to monitor temperature of the external contacts 200, internal contacts 230, interconnectors 260, or actuator 270, and (4) proximity or presence sensors configured to detect engagement of an external connector with the external contacts 200. Additional sensor inputs may include force or torque sensors associated with the actuator 270, isolation or ground-fault sensors configured to detect electrical isolation faults, and communication or signalling inputs received from external charging equipment or vehicle subsystems. The system controller 150 may use any combination of these sensor inputs to identify charging conditions, verify a selected operating mode, determine a safe time to change the position of the movable interconnecting unit 250, and enable or inhibit power transfer through the multifunctional mechanically reconfigurable charging port 110.

In some examples and with reference to block 310, the one or more inputs received at the system controller 150 may be provided from one or more external devices communicatively coupled to the system controller 150. For example, an external user device, such as a mobile phone, tablet, or other computing device, may be communicatively coupled to the system controller 150 via a wired or wireless communication link and configured to allow a user to select, request, or authorize an operating mode of the multifunctional mechanically reconfigurable charging port 110. In such examples, the user device may provide inputs corresponding to a desired charging mode, a desired power export mode, a scheduled charging or export time, or user authorization information, which may be used by the system controller 150 when selecting one of the operating modes.

In the same or other examples, the one or more inputs may be provided from an external system controller associated with external equipment. For example, an external controller of an AC or DC charging device, a vehicle-to-grid (V2G) system, and/or a power grid management system may be communicatively coupled to the system controller 150 and configured to provide inputs indicating an available power type, an available power level, a grid demand condition, or a requested direction of power flow. Based on such inputs, the system controller 150 may automatically select or modify an operating mode of the multifunctional mechanically reconfigurable charging port 110 and instruct the actuator 270 to change the position of the movable interconnecting unit 250 accordingly.

In some examples, the system controller 150 is configured to arbitrate between inputs received from internal vehicle systems and inputs received from external devices or external controllers, for example, by prioritizing safety-related inputs, verifying authorization or compatibility, and ensuring that changes in operating mode are performed only when predetermined conditions are satisfied.

Method 300 may proceed with (block 320) selecting, by the system controller 150, one of the operating modes for the multifunctional mechanically reconfigurable charging port 110. Various examples of the operating modes are described above. For example, the operating modes may comprise a combined DC charging and export-power mode, an AC charging-only mode, a DC charging-only mode, and an export-power-only mode. Selection of a particular operating mode by the system controller 150 may be based on one or more of the inputs received at block 310.

In some examples, the AC charging-only mode is selected when voltage and signalling detected on the first charge contact 201 and the second charge contact 202 indicate connection to an AC power source, when input from the battery management system indicates that charging is permitted, and when no export of power is requested. In such examples, the system controller 150 may further verify that one or more of the temperature, current, and isolation sensor inputs are within predetermined thresholds before selecting the AC charging-only mode.

In some examples, the DC charging-only mode is selected when voltage levels, polarity, or communication inputs received from external charging equipment indicate availability of DC charging power, and when the battery management system indicates that direct DC charging of the battery 130 is allowed. The system controller 150 may additionally select the DC charging-only mode based on a requested charging rate, a state of charge of the battery 130, or operating limits of the onboard charger 120.

In some examples, the export-power-only mode is selected when an external request for power export is received, such as from an external device, an external charger, a grid controller, or a user device, and when the battery management system indicates sufficient available energy in the battery 130. The system controller 150 may further select this mode based on grid demand conditions, time-of-use information, or user authorization inputs.

In some examples, the combined DC charging and export-power mode is selected when DC charging power is available at the external contacts 200 and a simultaneous request for power export is present, for example, to support vehicle-to-grid or vehicle-to-load operation while charging. In such examples, the system controller 150 may ensure that operating limits for temperature, current, and electrical isolation are satisfied before enabling the combined mode.

In some examples, the system controller 150 may be configured to apply prioritization rules, safety checks, and authorization requirements when selecting the operating mode, and to change the operating mode only when predetermined conditions are satisfied to ensure safe and reliable operation of the multifunctional mechanically reconfigurable charging port 110.

Method 300 may proceed with (block 330) changing, using the actuator 270, position of the movable interconnecting unit 250 relative to the external contacts 200 and the internal contacts 230 based on the one of operating modes of the multifunctional mechanically reconfigurable charging port 110 selected by the system controller 150. This may be referred to as switching the mode. Various new contacts are formed between the external contacts 200 and the internal contacts 230 as described above with reference to FIGS. 4A-4D.

Method 300 may proceed with (block 340) with operating the electric vehicle 100 in accordance with the operating mode established in the previous operation, e.g., charging the battery 130, exporting the power, etc.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A multifunctional mechanically reconfigurable charging port for an electric vehicle comprising an onboard charger, a battery, and a system controller, the multifunctional mechanically reconfigurable charging port comprising:
external contacts for forming electrical connections to external components, wherein the external contacts comprise at least a first charge contact and a second charge contact;
internal contacts comprising a first DC contact, a second DC contact, a first AC contact, and a second AC contact, wherein:
the first AC contact and the second AC contact are configured to form electrical connections to the onboard charger of the electric vehicle, and
the first DC contact and the second DC contact are configured to form electrical connections to the battery of the electric vehicle; and
a mechanical switch comprising a movable interconnecting unit and an actuator mechanically coupled to the movable interconnecting unit and configured to change position of the movable interconnecting unit relative to the external contacts and the internal contacts based on one of operating modes of the multifunctional mechanically reconfigurable charging port received from the system controller, wherein:
the movable interconnecting unit comprises a support and interconnectors attached to and supported by the support,
the interconnectors comprise at least a first interconnector and a second interconnector,
the first interconnector is configured to form an electrical connection between the first charge contact and one of the first DC contact and the first AC contact based on the position of the movable interconnecting unit relative to the external contacts and the internal contacts, and
the second interconnector is configured to form an electrical connection between the second charge contact and one of the second DC contact and the second AC contact based on the position of the movable interconnecting unit relative to the external contacts and the internal contacts.

2. The multifunctional mechanically reconfigurable charging port of claim 1, wherein:
the external contacts further comprise a first power export contact and a second power export contact,
the first interconnector is configured to form an electrical connection between the first power export contact and the first AC contact based on the position of the movable interconnecting unit relative to the external contacts and the internal contacts, and
the second interconnector is configured to form an electrical connection between the second power export contact and the second AC contact based on the position of the movable interconnecting unit relative to the external contacts and the internal contacts.

3. The multifunctional mechanically reconfigurable charging port of claim 2, wherein:
the interconnectors further comprise a third interconnector and a fourth interconnector,
the third interconnector is configured to form an electrical connection between the first power export contact and the first AC contact when the first interconnector forms the electrical connection between the first charge contact and the first DC contact, and
the fourth interconnector is configured to form an electrical connection between the second power export contact and the second AC contact when the second interconnector forms the electrical connection between the second charge contact and the second DC contact.

4. The multifunctional mechanically reconfigurable charging port of claim 3, wherein:
the operating modes comprise a combined DC-changing and export-power mode, and
when the position of the movable interconnecting unit relative to the external contacts and the internal contacts is according to the combined DC-changing and export-power mode:
(a) the first interconnector forms the electrical connection between the first charge contact and the first DC contact,
(b) the second interconnector forms the electrical connection between the second charge contact and the second DC contact,
(c) the third interconnector forms the electrical connection between the first power export contact and the first AC contact, and
(d) the fourth interconnector forms the electrical connection between the second power export contact and the second AC contact.

5. The multifunctional mechanically reconfigurable charging port of claim 3, wherein:
the operating modes comprise an AC charging-only mode, and
when the position of the movable interconnecting unit relative to the external contacts and the internal contacts is according to the AC charging-only mode:
(a) the first interconnector forms the electrical connection between the first charge contact and the first AC contact,
(b) the second interconnector forms the electrical connection between the second charge contact and the second AC contact, and
(c) each of the third interconnector and the fourth interconnector is disconnected from any of the internal contacts.

6. The multifunctional mechanically reconfigurable charging port of claim 3, wherein:
the operating modes comprise an export power-only mode, and
when the position of the movable interconnecting unit relative to the external contacts and the internal contacts is according to the export power-only mode:
(a) the first interconnector forms the electrical connection between the first power export contact and the first AC contact,
(b) the second interconnector forms the electrical connection between the second power export contact and the second AC contact, and
(c) each of the third interconnector and the fourth interconnector is disconnected from any of the internal contacts.

7. The multifunctional mechanically reconfigurable charging port of claim 3, wherein:
the operating modes comprise a DC charging-only mode, and
when the position of the movable interconnecting unit relative to the external contacts and the internal contacts is according to the DC charging-only mode:
(a) the third interconnector forms the electrical connection between the first charge contact and the first DC contact,
(b) the fourth interconnector forms the electrical connection between the second charge contact and the second DC contact, and
(c) each of the first interconnector and the second interconnector is disconnected from any of the internal contacts.

8. The multifunctional mechanically reconfigurable charging port of claim 1, further comprising the system controller comprising a memory with the operating modes stored in the memory, wherein the system controller is configured to receive input from one or more systems of the electric vehicle for selecting one of the operating modes.

9. The multifunctional mechanically reconfigurable charging port of claim 8, wherein the system controller is configured to coordinate operation of the actuator with the onboard charger.

10. The multifunctional mechanically reconfigurable charging port of claim 8, wherein the system controller is configured to inhibit movement of the actuator while electrical power is being transferred through the external contacts.

11. The multifunctional mechanically reconfigurable charging port of claim 8, wherein the system controller is configured to verify a position of the movable interconnecting unit prior to enabling power transfer.

12. The multifunctional mechanically reconfigurable charging port of claim 8, wherein the input received from one or more systems of the electric vehicle is selected from the group consisting of (a) a voltage readings on the first charge contact and the second charge contact, (b) battery management system input, and (c) and a sensor input from one or more sensors of the multifunctional mechanically reconfigurable charging port.

13. The multifunctional mechanically reconfigurable charging port of claim 12, wherein the system controller is configured to determine whether an external power source is an AC power source or a DC power source based on the voltage readings on the first charge contact and the second charge contact.

14. The multifunctional mechanically reconfigurable charging port of claim 12, wherein the one or more sensors comprise at least one sensor selected from the group consisting of:
a position sensor configured to detect a position of the movable interconnecting unit,
a current sensor configured to detect current flowing through one or more of the external contacts or the internal contacts,
a temperature sensor configured to detect temperature of one or more of the external contacts, the internal contacts, the interconnectors, or the actuator, and
a proximity sensor configured to detect engagement of an external connector with the external contacts.

15. The multifunctional mechanically reconfigurable charging port of claim 8, wherein the system controller is configured to select the one of the operating modes based on at least one factor selected from the group consisting of an available power type, an available power level, a state of charge of the battery, a grid demand condition, a user authorization input, and a requested direction of power flow.

16. The multifunctional mechanically reconfigurable charging port of claim 1, wherein the support is formed from an electrically insulating material configured to maintain electrical isolation between the interconnectors.

17. The multifunctional mechanically reconfigurable charging port of claim 1, wherein the support has a cylindrical shape enabling rotational movement of the movable interconnecting unit.

18. The multifunctional mechanically reconfigurable charging port of claim 1, wherein the actuator is a rotary actuator.

19. An electric vehicle comprising:
a multifunctional mechanically reconfigurable charging port comprising external contacts, internal contacts, and a mechanical switch, wherein the mechanical switch comprises a movable interconnecting unit and an actuator mechanically coupled to the movable interconnecting unit;
an onboard charger;
a battery connected to the onboard charger; and
a system controller configured to select one of operating modes of the multifunctional mechanically reconfigurable charging port and instruct the actuator to change position of the movable interconnecting unit relative to the external contacts and the internal contacts based on the one of the operating modes selected by the system controller, wherein:
the external contacts are configured to form electrical connections to external components and comprise at least a first charge contact and a second charge contact,
the internal contacts comprise a first DC contact, a second DC contact, a first AC contact, and a second AC contact,
the first AC contact and the second AC contact are connected to the onboard charger,
the first DC contact and the second DC contact are connected to the battery of the electric vehicle.

20. A method of operating an electric vehicle comprising a multifunctional mechanically reconfigurable charging port, an onboard charger, a battery, and a system controller, the method comprising:
receiving, at the system controller, one or more inputs;
selecting, by the system controller, one of operating modes for the multifunctional mechanically reconfigurable charging port, wherein:
the multifunctional mechanically reconfigurable charging port comprises external contacts, internal contacts, and a mechanical switch comprising a movable interconnecting unit and an actuator,
the external contacts comprise at least a first charge contact and a second charge contact,
the internal contacts comprise a first DC contact, a second DC contact, a first AC contact, and a second AC contact,
the actuator is mechanically coupled to the movable interconnecting unit, and
the movable interconnecting unit comprises a support and interconnectors attached to and supported by the support and comprising at least a first interconnector and a second interconnector; and
changing, using the actuator, position of the movable interconnecting unit relative to the external contacts and the internal contacts based on the one of the operating modes of the multifunctional mechanically reconfigurable charging port selected by the system controller.
